(19) United States
(12) Patent Application Publication
(10) Pub. No.: US 2012/0079249 A1
(43) Pub. Date: Mar. 29, 2012

(54) Training Decode Unit for Previously-Detected Instruction Type

(76) Inventors: Wei-Han Lien, San Jose, CA (US); Ian D. Kountanis, Santa Clara, CA (US); Shyam Sundar, Sunnyvale, CA (US)

(21) Appl. No.: 12/892,438

(22) Filed: Sep. 28, 2010

(51) Int. Cl. G06F 9/30

(52) U.S. Cl. 712/212; 712/E09.016

(57) ABSTRACT

In an embodiment, a decode unit includes multiple decoders configured to decode different types of instructions. One or more of the decoders may be complex decoders, and the decode unit may disable the complex decoders if an instruction of the corresponding type is not being decoded. In an embodiment, the decode unit may disable the complex decoders by data-gating the instruction into the decoder. The decode unit may also include a control unit that is configured to detect instructions of the type decoded by the complex decoders, and to enable the complex decoders and redirect the fetching in response to the detection. The decode unit may also record an indication of the instruction (e.g. the program counter address (PC) of the instruction) to more rapidly detect the instruction and prevent a redirect in subsequent fetches.

### BACKGROUND

1. Field of the Invention

This invention is related to the field of processors and, more specifically, to decoding instructions in processors.

2. Description of the Related Art

As the number of transistors included on an integrated circuit “chip” continues to increase, power management in the integrated circuits continues to increase in importance. Power management can be critical to integrated circuits that are included in mobile devices such as personal digital assistants (PDAs), cell phones, smart phones, laptop computers, net top computers, etc. These mobile devices often rely on battery power, and reducing power consumption in the integrated circuits can increase the life of the battery. Additionally, reducing power consumption can reduce the heat generated by the integrated circuit, which can reduce cooling requirements in the device that includes the integrated circuit (whether or not it is relying on battery power).

Clock gating is often used to reduce dynamic power consumption in an integrated circuit, disabling the clock to idle circuitry and thus preventing switching in the idle circuitry. Some integrated circuits have implemented power gating in addition to clock gating. With power gating, the power to ground path of the idle circuitry is interrupted, reducing the leakage current to near zero.

Clock gating and power gating are typically coarse-grained mechanisms for controlling power consumption. For example, clock gating is typically applied to a circuit block as a whole, or to a significant portion of a circuit block. Similarly, power gating is typically applied to a circuit block as a whole.

### SUMMARY

In an embodiment, a decode unit includes multiple decoders configured to decode different types of instructions (e.g. integer, vector, load/store, etc.). One or more of the decoders may be complex decoders that may consume more power than other decoders. The decode unit may disable the complex decoders if an instruction of the corresponding type is not being decoded. Accordingly, the power that would be consumed in the decoder may be conserved. In an embodiment, the decode unit may disable the complex decoders by data-gating the instruction into the complex decoder, which prevents the decode circuitry from switching. The decode unit may also include a control unit that is configured to detect instructions of the type decoded by the complex decoders, and to enable the complex decoders. The detection, enabling, and decoding in the complex decoder may not be achievable within the same clock cycle that the instruction arrives at the decode unit, and thus a redirect may be signalled. When the instruction returns to the decode unit after the redirect, the complex decoder may be enabled. The decode unit may also record an indication of the instruction (e.g. the program counter address (PC) of the instruction) to more rapidly detect the instruction in future clock cycles in which the complex decoder is enabled, and may prevent a redirect in such situations.

Particularly, in an embodiment, vector integer instructions and vector floating point instructions may each have corresponding complex decoders. These instructions may also be relatively rare in many general purpose code sequences, but the occurrence of a vector instruction in a code sequence may indicate that additional vector instructions are more likely in that sequence. Accordingly, the vector decoders may be enabled responsive to detecting a vector instruction, and may remain enabled until vector instructions have not been detected for a time period (e.g. a number of clock cycles). The vector decoders may then be disabled, and may be enabled again in response to a subsequent detection of a vector instruction in the decode unit.

Accordingly, in an embodiment, a fine-grain power consumption control mechanism may be provided in which individual decoders may be disabled, at least temporarily, to conserve the power that would otherwise be consumed in those decoders. Such techniques may augment coarse-grain techniques such as clock gating or power gating, or may be used in embodiments in which coarse-grain techniques are not used.

### BRIEF DESCRIPTION OF THE DRAWINGS

The following detailed description makes reference to the accompanying drawings, which are now briefly described.

FIG. 1 is a block diagram of one embodiment of an integrated circuit.

FIG. 2 is a block diagram of at least a portion of a processor shown in FIG. 1.

FIG. 3 is a flowchart illustrating operation of one embodiment of a control circuit shown in FIG. 2.

FIG. 4 is a block diagram of one embodiment of a system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

An overview of a system on a chip which includes one or more processors is described first, followed by a description of decode units that may be implemented in one embodiment of the processors and which may implement the power saving features mentioned above. That is, the decode units may include decoders that decode various instruction types, and at least some of the decoders may be disabled if the corresponding instruction types are not detected. The decode units may also employ techniques to effectively predict when the instruction type for a disabled decoder may appear (e.g. by recording indications such as the PC of the instruction which was received while the decoder was disabled and comparing the PCs of received instructions).

### Overview

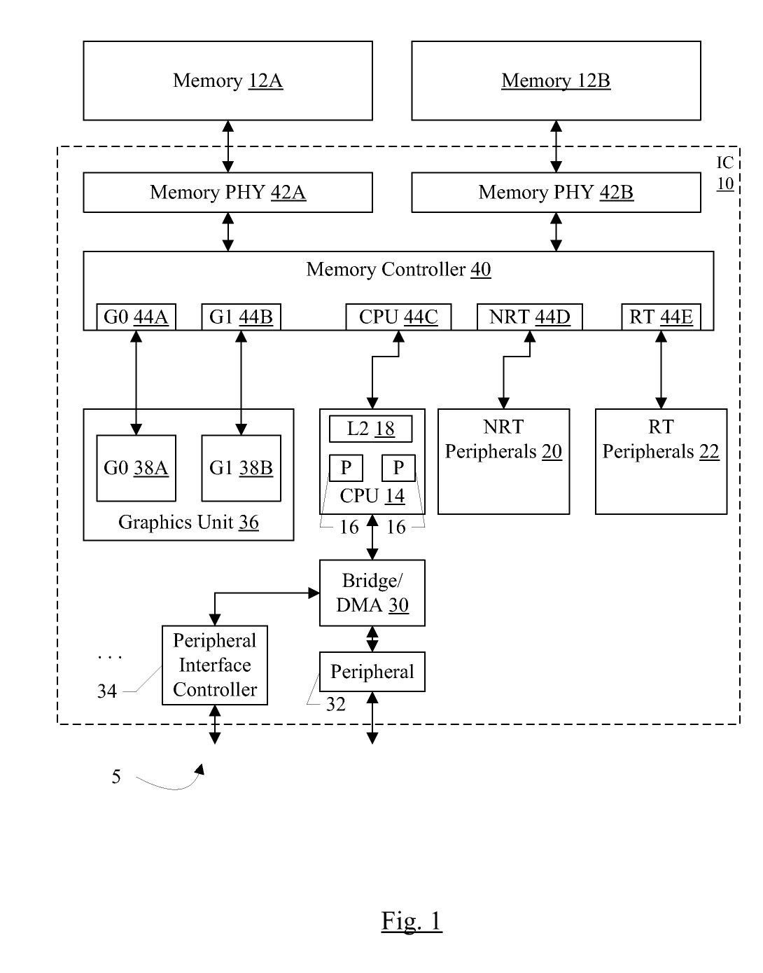

Turning now to FIG. 1, a block diagram of one embodiment of a system 5 is shown. In the embodiment of FIG. 1, the system 5 includes an integrated circuit (IC) 10 coupled to external memories 12A-12B. In the illustrated embodiment, the integrated circuit 10 includes a central processor unit (CPU) block 14 which includes one or more processors 16 and a level 2 (L2) cache 18. Other embodiments may not include L2 cache 18 and/or may include additional levels of cache. Additionally, embodiments that include more than two processors 16 and that include only one processor 16 are contemplated. The integrated circuit 10 further includes a set of one or more non-real time (NRT) peripherals 20 and a set of one or more real time (RT) peripherals 22. In the illustrated embodiment, the CPU block 14 is coupled to a bridge/direct memory access (DMA) controller 30, which may be coupled to one or more peripheral devices 32 and/or one or more peripheral interface controllers 34. The number of peripheral devices 32 and peripheral interface controllers 34 may vary from zero to any desired number in various embodiments. The system 5 illustrated in FIG. 1 further includes a graphics unit 36 comprising one or more graphics controllers such as G0 38A and G1 38B. The number of graphics controllers per graphics unit and the number of graphics units may vary in other embodiments. As illustrated in FIG. 1, the system 5 includes a memory controller 40 coupled to one or more memory physical interface circuits (PHYs) 42A-42B. The memory PHYs 42A-42B are configured to communicate on pins of the integrated circuit 10 to the memories 12A-12B. The memory controller 40 also includes a set of ports 44A-44E. The ports 44A-44B are coupled to the graphics controllers 38A-38B, respectively. The CPU block 14 is coupled to the port 44C. The NRT peripherals 20 and the RT peripherals 22 are coupled to the ports 44D-44E, respectively. The number of ports included in a memory controller 40 may be varied in other embodiments, as may the number of memory controllers. That is, there may be more or fewer ports than those shown in FIG. 1. The number of memory PHYs 42A-42B and corresponding memories 12A-12B may be one or more than two in other embodiments.

Generally, a port may be a communication point on the memory controller 40 to communicate with one or more sources. In some cases, the port may be dedicated to a source (e.g. the ports 44A-44B may be dedicated to the graphics controllers 38A-38B, respectively). In other cases, the port may be shared among multiple sources (e.g. the processors 16 may share the CPU port 44C, the NRT peripherals 20 may share the NRT port 44D, and the RT peripherals 22 may share the RT port 44E. Each port 44A-44E is coupled to an interface to communicate with its respective agent. The interface may be any type of communication medium (e.g. a bus, a point-to-point interconnect, etc.) and may implement any protocol. The interconnect between the memory controller and sources may also include any other desired interconnect such as meshes, network on a chip fabrics, shared buses, point-to-point interconnects, etc.

The processors 16 may implement any instruction set architecture, and may be configured to execute instructions defined in that instruction set architecture. The processors 16 may employ any microarchitecture, including scalar, superscalar, pipelined, superpipelined, out of order, in order, speculative, non-speculative, etc., or combinations thereof. The processors 16 may include circuitry, and optionally may implement microcoding techniques. The processors 16 may include one or more level 1 caches, and thus the cache 18 is an L2 cache. Other embodiments may include multiple levels of caches in the processors 16, and the cache 18 may be the next level down in the hierarchy. The cache 18 may employ any size and any configuration (set associative, direct mapped, etc.).

The graphics controllers 38A-38B may be any graphics processing circuitry. Generally, the graphics controllers 38A-38B may be configured to render objects to be displayed into a frame buffer. The graphics controllers 38A-38B may include graphics processors that may execute graphics software to perform a part or all of the graphics operation, and/or hardware acceleration of certain graphics operations. The amount of hardware acceleration and software implementation may vary from embodiment to embodiment.

The NRT peripherals 20 may include any non-real time peripherals that, for performance and/or bandwidth reasons, are provided independent access to the memory 12A-12B. That is, access by the NRT peripherals 20 is independent of the CPU block 14, and may proceed in parallel with CPU block memory operations. Other peripherals such as the peripheral 32 and/or peripherals coupled to a peripheral interface controlled by the peripheral interface controller 34 may also be non-real time peripherals, but may not require independent access to memory. Various embodiments of the NRT peripherals 20 may include video encoders and decoders, scaler circuitry and image compression and/or decompression circuitry, etc.

The RT peripherals 22 may include any peripherals that have real time requirements for memory latency. For example, the RT peripherals may include an image processor and one or more display pipes. The display pipes may include circuitry to fetch one or more frames and to blend the frames to create a display image. The display pipes may further include one or more video pipelines. The result of the display pipes may be a stream of pixels to be displayed on the display screen. The pixel values may be transmitted to a display controller for display on the display screen. The image processor may receive camera data and process the data to an image to be stored in memory.

The bridge/DMA controller 30 may comprise circuitry to bridge the peripheral(s) 32 and the peripheral interface controller(s) 34 to the memory space. In the illustrated embodiment, the bridge/DMA controller 30 may bridge the memory operations from the peripherals/peripheral interface controllers through the CPU block 14 to the memory controller 40. The CPU block 14 may also maintain coherence between the bridged memory operations and memory operations from the processors 16/L2 Cache 18. The L2 cache 18 may also arbitrate the bridged memory operations with memory operations from the processors 16 to be transmitted on the CPU interface to the CPU port 44C. The bridge/DMA controller 30 may also provide DMA operation on behalf of the peripherals 32 and the peripheral interface controllers 34 to transfer blocks of data to and from memory. More particularly, the DMA controller may be configured to perform transfers to and from the memory 12A-12B through the memory controller 40 on behalf of the peripherals 32 and the peripheral interface controllers 34. The DMA controller may be programmable by the processors 16 to perform the DMA operations. For example, the DMA controller may be programmable via descriptors. The descriptors may be data structures stored in the memory 12A-12B that describe DMA transfers (e.g. source and destination addresses, size, etc.). Alternatively, the DMA controller may be programmable via registers in the DMA controller (not shown).

The peripherals 32 may include any desired input/output devices or other hardware devices that are included on the integrated circuit 10. For example, the peripherals 32 may include networking peripherals such as one or more networking media access controllers (MAC) such as an Ethernet MAC or a wireless fidelity (WiFi) controller. An audio unit including various audio processing devices may be included in the peripherals 32. One or more digital signal processors may be included in the peripherals 32. The peripherals 32 may include any other desired functional such as timers, an on-chip secrets memory, an encryption engine, etc., or any combination thereof.

The peripheral interface controllers 34 may include any controllers for any type of peripheral interface. For example, the peripheral interface controllers may include various interface controllers such as a universal serial bus (USB) controller, a peripheral component interconnect express (PCIe) controller, a flash memory interface, general purpose input/output (I/O) pins, etc.

The memories 12A-12B may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with the integrated circuit 10 in a chip-on-chip configuration, a package-on-package configuration, or a multi-chip module configuration.

The memory PHYs 42A-42B may handle the low-level physical interface to the memory 12A-12B. For example, the memory PHYs 42A-42B may be responsible for the timing of the signals, for proper clocking to synchronous DRAM memory, etc. In one embodiment, the memory PHYs 42A-42B may be configured to lock to a clock supplied within the integrated circuit 10 and may be configured to generate a clock used by the memory 12.

It is noted that other embodiments may include other combinations of components, including subsets or supersets of the components shown in FIG. 1 and/or other components. While one instance of a given component may be shown in FIG. 1, other embodiments may include one or more instances of the given component. Similarly, throughout this detailed description, one or more instances of a given component may be included even if only one is shown, and/or embodiments that include only one instance may be used even if multiple instances are shown.

### Processor

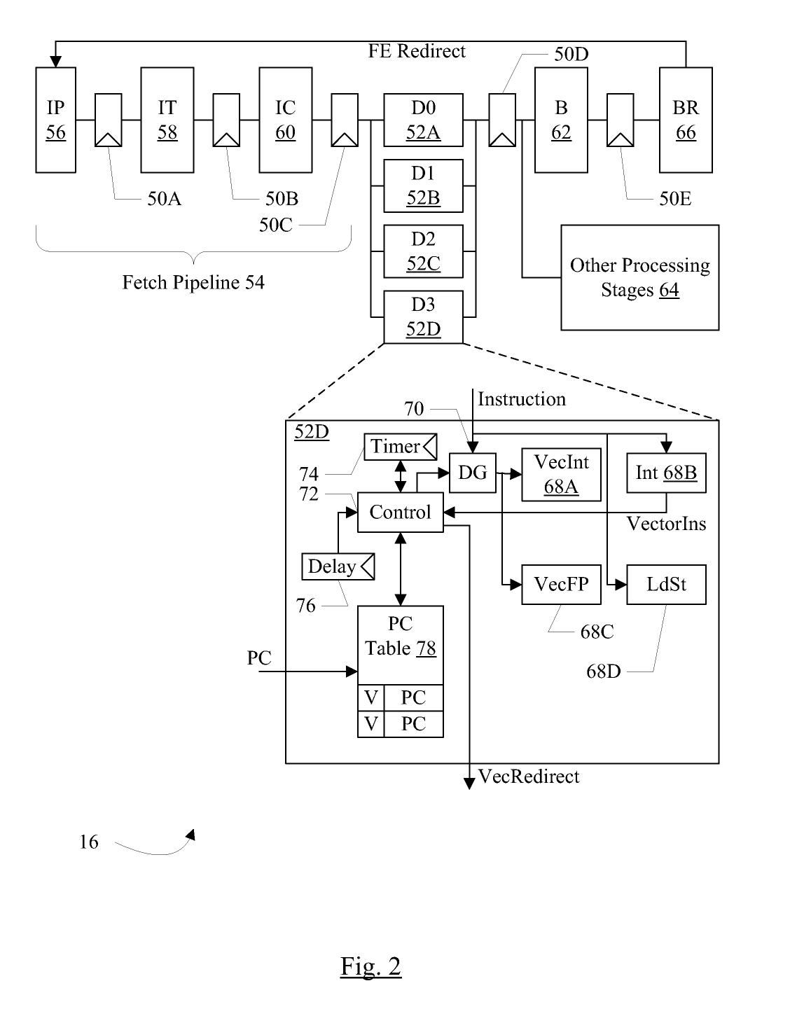

Turning now to FIG. 2, a block diagram of a portion of one embodiment of a processor 16 is shown. The embodiment illustrated in FIG. 2 is illustrated in the form of a pipeline with various blocks of circuitry separated by clocked storage devices 50A-50E (e.g. flops, although any clocked storage devices such as registers, latches, etc. may be used in other embodiments). Each flop 50A-50E may represent multiple flops in parallel to capture the data provided by the preceding stage and to propagate the data to the subsequent stage. The pipeline may vary in other embodiments, but may generally include at least one pipeline stage at which instructions are decoded in one or more decode units. For example, the decode units 52A-52D shown in FIG. 2 may form a decode stage of the pipeline. The decode units 52A-52D may also form multiple decode pipeline stages, in some embodiments (e.g. if decode consumes more than one clock cycle). Other embodiments may include more or fewer decode units, including as few as one decode unit. In the illustrated embodiment, the decode units 52A-52D may be coupled to receive instructions from a fetch pipeline 54, which may include a PC generation stage (IP) 56, an instruction cache tag (IT) stage 58, and an instruction cache data (IC) stage 60 in the embodiment of FIG. 2. Flops 50A, 50B, and 50C are coupled to receive the outputs of the stages 56, 58, and 60, respectively. The flop 50D is coupled to receive the output of the decode units 52A-52D, and is coupled to a branch (B) stage 62 and various other processing stages 64. The output of the branch stage is captured by the flop 50E and provided to the branch redirect stage 66, which is coupled to provide a front end redirect (FE_Redirect in FIG. 2) to the IP stage 56.

The decode unit 52D is shown in exploded view in FIG. 2. Other decode units 52A-52C may be similar. That is, each of the other decode units 52A-52C may include the same hardware as that shown in FIG. 2 for the decode unit 52D, in an embodiment. Such a configuration may be referred to as symmetrical decode units. In other embodiments, some decode units may have different hardware than others (asymmetrical decode units). In such embodiments, some decode units may be dedicated to decoding certain instruction types, and there may be predecoding (either stored in the instruction cache or performed in the IC stage 60) to determine the instruction type and route the instruction to the correct decode unit. In the illustrated embodiment, the decoder 52D is coupled to receive an instruction and a PC of the instruction from the preceding IC stage 60. Additional data may be received by the decode unit 52D as well. Other decode units 52A-52C may also be coupled to receive respective instructions, PCs, and additional data as well. Accordingly, up to four instructions may be fetched and decoded concurrently, in this embodiment.

The decode unit 52D includes multiple decoders. For example, in the embodiment of FIG. 2, the decoders include the vector integer (VecInt) decoder 68A, the integer (Int) decoder 68B, the vector floating point (VecFP) decoder 68C, and the load/store (LdSt) decoder 68D. Some of the decoders (e.g. the decoders 68B and 68D) are coupled to receive the instruction directly. Other decoders (e.g. the decoders 68A and 68C) are coupled to receive a data-gated instruction from a data gating circuit (DG) 70. The data gating circuit 70 is coupled to a control circuit 72, which is coupled to a timer 74, a programmable delay 76, and a PC table 78 in this embodiment. The PC table 78 is also coupled to receive the PC of the instruction provided to the decode unit 52D, in this embodiment.

Generally, each decoder 68A-68D may be configured to decode instructions of a designated type. Instructions in the instruction set architecture implemented in the processor 16 may broadly be characterized into instruction types based on a similarity in operations that the instructions are defined to cause, when executed in the processor, and/or based on the operands on which the instructions operate. Accordingly, instruction types may include load/store instructions (which read and write memory), arithmetic/logic instructions, and control instructions (such as branch instructions). The arithmetic/logic instructions may further be divided into operand types, such as integer, floating point (not shown in FIG. 2), vector integer, and vector floating point. Vector operand types may be single instruction, multiple data (SIMD) data types in which the operand (e.g. a value read from or written to a register) is logically divided into multiple fields. Each field is operated upon independent of the other fields. For example, a carry out of one field does not carry into the next field if an addition is being performed on the operand. Thus, the operand may be a vector of two or more data values. Accordingly, the vector integer decoder 68A may be configured to decode vector integer instructions; the vector floating point decoder 68C may be configured to decode vector floating point instructions; the integer decoder 68B may be configured to decode integer instructions; and the load/store decoder 68D may be configured to decode load/store instructions. A branch decoder may be included to decode control instructions, or the integer decoder 68B may be configured to decode control instructions as well. Instruction set architectures that include non-vector floating point instructions may also include a floating point decoder. Generally, any set of instruction types and corresponding decoders may be used.

In this embodiment, the vector decoders 68A and 68C may be complex decoders, and thus may be larger and may consume more power than the integer decoder 68B and the load/store decoder 68D. By providing the vector decoders 68A and 68C with data-gated instructions, these decoders may be disabled during times that vector instructions are not being encountered. Data gating may generally refer to forcing the data input to a circuit (e.g. a decoder) to a known value. The circuitry receiving the data-gated input may not switch as long as the input data remains constant, reducing power consumption. The known value may be any desired value in various embodiments. For example, the data-gated instruction may be all zero. In such and embodiment, the instruction may be logically ANDed with a control signal that is one if gating is not being performed and zero if gating is being performed. Other embodiments may force the data to all ones, or to any combination of ones and zeros.

The control circuit 72 may be configured to activate the data gating circuit 70 to disable the decoders 68A and 68C, or to deactivate the data gating circuit 70 to enable the decoders 68A and 68C. In one embodiment, the control circuit 72 may be configured to measure a period of time since the most recent detection of a vector instruction, and may disable the decoders 68A and 68C after the period of time passes without detecting another vector instruction. For example, the timer 74 may be a counter used to measure the period of time (e.g. in terms of clock cycles). In one embodiment, the processor 16 may be programmable with the period of time (e.g. by programming the delay register 76 with the desired number of clock cycles). In other embodiments, the period of time may be fixed.

In one embodiment, control circuit 72 may be configured to initialize the timer 74 with the delay value and to decrement the timer 74 each clock cycle that a vector instruction is not detected. If a vector instruction is detected, the control circuit 72 may be configured to reset the timer to the delay value. If the timer 74 reaches zero, the control circuit 72 may be configured activate the data gating circuit 70, disabling the vector decoders 68A and 68C. The control circuit 72 may be configured to continue activating the data gating circuit 70/disabling the vector decoders 68A and 68C until another vector instruction is detected. Other embodiments may initialize/reset the timer to zero and increment the timer, activating the data gating circuit 70 in response to the timer reaching the delay value. Generally, the timer may be referred to as expiring if it is decremented to zero or incremented to the delay value in these embodiments.

The control circuit 72 may also be configured to assert the vector redirect signal in response to the integer decoder 68B signalling a vector instruction while the data gating circuit 70 is active. There may not be enough time in a clock cycle for the integer decoder 68B to detect the vector instruction, signal the control circuit 72, deactivate the data gating circuit 70, and decode the vector instruction. The vector redirect may be pipelined through the branch stage 62 to the branch redirect stage 66. The branch redirect stage 66 may combine the vector redirect with other front end redirects to generate the FE_Redirect. For example, the other front end redirects may include branch mispredictions detected by the branch stage 62. Alternatively, the control circuit 72 may be configured to signal the redirect to the PC generation stage 56.

Generally, a redirect (for an instruction) may refer to purging the instruction (and any subsequent instructions, in program order) from the pipeline, and refetching beginning at the instruction for which the redirect is signalled. Accordingly, the redirect indication may include the PC of the instruction to be refetched, as well as one or more signals indicating the redirect.

Since performance may be lost when redirects occur, the decode unit 52D may include the PC table 78 to attempt to predict the occurrence of vector instructions before they can be confirmed by the integer unit 68B. The PC table may include multiple entries, each of which may store at least a portion of a PC of a vector instruction. In some embodiments, only a portion of the PC is stored. In other embodiments, an entirety of the PC is stored. There may also be a valid bit in each entry (V in FIG. 2) indicating whether or not the entry is valid. The table 78 may be trained with PCs of vector instructions, and the PC of an instruction provided to the decode unit 52D may be compared to the PCs in the table. If a match is detected (the PCs are equal, or the portion stored in the table and the corresponding portion of the input PC are equal), the control circuit 72 may be configured to deactivate the data gating circuit 70. The vector decoders 68A and 68C may thus be enabled and may decode the vector instruction. The time elapsing to perform the PC compare, deactivate the data gating circuit 70, and decode the vector instruction may meet cycle time requirements and thus there may be no need to redirect the instruction fetching in cases in which the PC is a hit in the PC table. Viewed in another way, a faster cycle time may be supported using the PC table 78 and redirecting in cases that: (i) a vector instruction is detected by the integer unit 68B while the vector decoders 68A and 68C are disabled; and (ii) the PC table 78 did not predict the vector instruction.

In one embodiment, the PC of any vector instruction may be recorded in (written to) the PC table 78. In another embodiment, only vector instructions that are the initial vector instructions in a code sequence may be recorded in the PC table 78. In still another embodiment, only the PCs of vector instructions for which a redirect is signalled may be recorded in the PC table 78, to avoid a redirect on the next fetch of that vector instruction (if the PC is still in the PC table 78 at the next fetch). The number of entries in the PC table 78 may vary from embodiment to embodiment. The PC table 78 may be constructed in a variety of fashions (e.g. as a content addressable memory (CAM), as a set of discrete registers, etc.).

As mentioned previously, in some embodiments, only a portion of the PC may be stored in the PC table 78. While such an embodiment may not be completely accurate, the amount of storage needed for each PC may be less and thus more PCs may be represented in a given amount of storage. In some embodiments, the portion of the PC that is stored may include least significant bits of the PC (e.g. most significant bits may be dropped). Code that exhibits reasonable locality of reference may tend to have the same most significant bits for instructions fetched in temporal closeness to each other. Generally, the PC may be an address the locates an instruction in memory. The PC may be a physical address actually fetched from memory, or may be a virtual address that translates through an address translation structure such as page tables to the physical address. The PC used in the PC table 78 may be the virtual address or the physical address, in various embodiments.

In the illustrated embodiment, the integer decoder 68B is configured to detect vector instructions in addition to decoding the integer instructions. The detection may involve only determining that a vector instruction has been received, not fully decoding the instruction. Accordingly, the logic circuitry to perform the detection may be relatively small compared to the vector decoders 68A and 68C. The integer decoder may be configured to assert a vector instruction signal (VectorIns in FIG. 2) to the control circuit 72 in response to detecting the vector instruction. In other embodiments, any decoder that receives the ungated instruction may perform the detection.

The output of the decoders 68A-68D may be combined (e.g. a multiplexor (mux) may be provided to select between the outputs of the decoders 68A-68D, based on the type of instruction that is decoded, not shown in FIG. 2). The instruction may be transmitted to the next stage to the pipeline, such as the branch stage 62 and the other processing stages 64. Additionally, the PC of the instruction and any other additional data may be pipelined. The additional data may include the vector redirect (VecRedirect) signal generated by the control circuit 72 if a vector instruction is detected while the data gating circuit 70 is active.

The fetch pipeline 54 may generally include any circuitry and number of pipeline stages to fetch instructions and provide the instructions for decode. In the illustrated embodiment, the IP stage 56 may be used to generate fetch PCs. The IP stage 56 may include, for example, various branch prediction data structures configured to predict branches, and the fetch PC may be generated based on the predictions. The IP stage 56 may also receive the FE_Redirect and may be configured to redirect to the PC specified by the FE_Redirect. The IP stage 56 may also receive redirects from other parts of the processor pipeline (e.g. a back end redirect, not shown in FIG. 2, for faults, exceptions, and interrupts). The IT stage 58 may include circuitry configured to read the instruction cache tags, check for a hit, and schedule a cache fill for a miss. In the case of a cache hit, the IC stage 60 may include circuitry configured to read instructions from the instruction cache.

As mentioned above, the branch stage 62 may be configured to execute branch instructions and verify branch predictions. Branch mispredictions may result in front end redirects. The branch redirect stage 66 may be configured to signal the front end redirects for branches and for vector redirects.

The other processing stages 64 may include any set of pipeline stages for executing vector instructions, load/store instructions, integer instructions, etc. The other processing stages 64 may support in order or out of order execution, speculative execution, superscalar or scalar execution, etc.

It is noted that, while the vector decoders are complex decoders in this embodiment, other embodiments may have other decoders (configured to decode other instruction types) which are complex and which may achieve power conservation by disabling the decoders. Additionally, even if a decoder is not complex, if the instructions decoded by the decoder are relatively infrequent and the occurrence of an instruction that is decoded by the decoder is indicative that more such instructions may occur in the code sequence (similar to the vector instructions), the decoder may be disabled as discussed herein and may achieve power conservation.

In other embodiments, other mechanisms besides data gating may be used to disable a decoder. For example, some embodiments may clock gate a decoder to disable the decoder (e.g. if the decoder includes clocked storage devices). Alternatively, the decoder may include an explicit enable/disable signal which may be used to disable the decoder.

It is noted that, while the vector integer decoder 68A and the vector floating point decoder 68C are controlled as a unit in the embodiment of FIG. 2, other embodiments may track the two types of instructions independently and may control the decoders 68A and 68C independent, such that one of the decoders may be disabled when the other is enabled. Such an embodiment may include, for example, two timers 74 (one for each instruction type) and potentially two programmable delays (one for each instruction type). Separate PC tables 78 may be used for each instruction type, or an indication of instruction type (e.g. a bit indicating integer in one state and floating point in the opposite state) may be stored in each entry of the PC table 78.

In embodiments that employ symmetrical decode units 52A-52D, the control unit 72 and related circuitry may be shared across the decode units 52A-52D, such that the decode units 52A-52D either have vector decoders 68A and 68C enabled or disabled in synchronization. Alternatively, each decode unit 52A-52D may operate independently. For example, each decode unit 52A-52D may include its own instance of the control circuit 72, the timer 74, the delay register 76, and the PC table 78.

It is noted that, while one embodiment of the processor 16 may be implemented in the integrated circuit 10 as shown in FIG. 1, other embodiments may implement the processor 16 as a discrete component. Any level of integration of the processor 16 and one or more other components may be supported in various embodiments.

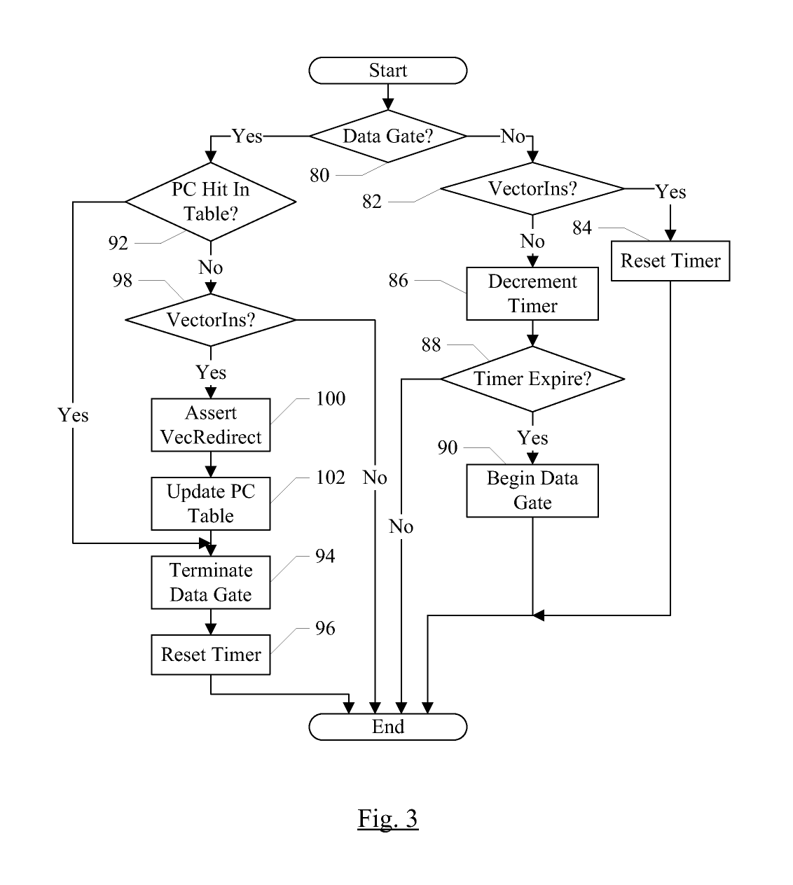

Turning now to FIG. 3, a flowchart is shown illustrating operation of one embodiment of the control circuit 72 for an embodiment. While the blocks are shown in a particular order for ease of understanding in FIG. 3, other orders may be used. Blocks may be performed in parallel in combinatorial logic circuitry in the control circuit 72. Blocks, combinations of blocks, and/or the flowchart as a whole may be pipelined over multiple clock cycles. The control circuit 72 may be configured to implement the operation shown in FIG. 3.

If the control circuit 72 is not currently data-gating the vector instructions (decision block 80, “no” leg), the control circuit 72 may be configured to determine if a currently-received instruction is a vector instruction (decision block 82). For example, the vector instruction signal input from the integer decoder 68B may be used. If the instruction is a vector instruction (decision block 82, “yes” leg), the control circuit 72 may be configured to reset the timer 74 (block 84). For example, the control circuit 72 may initialize the timer 74 to the delay value for this embodiment, which decrements the timer 74. Embodiments which increment the timer 74 may reload the timer 74 with zero. Since the control circuit 72 is not data-gating the vector decoders, the vector instruction may be correctly decoded. On the other hand, if the instruction is not a vector instruction (decision block 82, “no” leg), the control circuit 72 may be configured to decrement the timer 74 (block 86). If the timer 74 has expired (decision block 88, “yes” leg), the control circuit 72 may be configured to begin data-gating the vector decoders 68A and 68C (block 90). For example, the control circuit 72 may activate the data gating circuit 70. In other embodiments, the control circuit 72 may disable the vector decoders 68A and 68C in other ways.

If the control circuit 72 is currently data-gating the vector instructions (decision block 80, “yes” leg), the control circuit 72 may be configured to determine if a currently-received instruction's PC is a hit in the PC table (decision block 92). If so (decision block 92, “yes” leg), the control circuit 72 may be configured to terminate data-gating of the vector decoders (e.g. deactivating the data gating circuit 70) (block 94) and may reset the timer 74 (block 96) to begin measuring the delay interval again. If the currently-received instruction's PC is a miss in the PC table (decision block 92, “no” leg) and the integer decoder 68B detects a vector instruction (decision block 98, “yes” leg), the control circuit 72 may be configured to assert the vector redirect for the instruction (block 100). Additionally, the control circuit 72 may be configured to update the PC table 78 with the PC of the vector instruction (block 102). The control circuit 72 may terminate data gating (block 94) and reset the timer 74 (block 96) as well. It is noted that the circuitry implementing decision block 98 may be the same circuitry that implements decision block 82, in an embodiment.

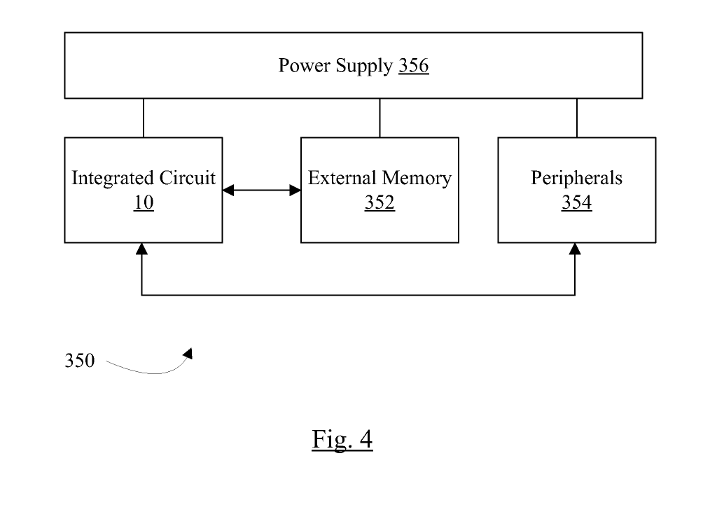

Turning next to FIG. 4 a block diagram of one embodiment of a system 350 is shown. In the illustrated embodiment, the system 350 includes at least one instance of an integrated circuit 10 coupled to an external memory 352. The external memory 352 may form the main memory subsystem discussed above with regard to FIG. 1 (e.g. the external memory 352 may include the memory 12A-12B). The integrated circuit 10 is coupled to one or more peripherals 354 and the external memory 352. A power supply 356 is also provided which supplies the supply voltages to the integrated circuit 358 as well as one or more supply voltages to the memory 352 and/or the peripherals 354. In some embodiments, more than one instance of the integrated circuit 10 may be included (and more than one external memory 352 may be included as well).

The memory 352 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 10 in a chip-on-chip configuration, a package-on-package configuration, or a multi-chip module configuration.

The peripherals 354 may include any desired circuitry, depending on the type of system 350. For example, in one embodiment, the system 350 may be a mobile device (e.g. personal digital assistant (PDA), smart phone, etc.) and the peripherals 354 may include devices for various types of wireless communication, such as wifi, Bluetooth, cellular, global positioning system, etc. The peripherals 354 may also include additional storage, including RAM storage, solid state storage, or disk storage. The peripherals 354 may include user interface devices such as a display screen, including touch display screens or multitouch display screens, keyboard or other input devices, microphones, speakers, etc. In other embodiments, the system 350 may be any type of computing system (e.g. desktop personal computer, laptop, workstation, net top etc.).

Numerous variations and modifications will become apparent to those skilled in the art once the above disclosure is fully appreciated. It is intended that the following claims be interpreted to embrace all such variations and modifications.

What is claimed is:

1. A decode unit comprising:
a plurality of decoders, wherein each of the plurality of decoders is configured to decode a different type of instruction;
a data gating circuit coupled to receive an instruction that is provided to the decode unit and configured to gate the instruction, wherein at least one of the plurality of decoders is coupled to receive the gated instruction from the data gating circuit, and wherein other ones of the plurality of decoders are coupled to receive the ungated instruction directly;
a control circuit configured to activate the data gating circuit responsive to not receiving an instruction of a first instruction type that is decoded by the at least one of the plurality of decoders and configured to deactivate the data gating circuit responsive to detecting an instruction of the first instruction type while the data gating circuit is gating the at least one of the plurality of decoders, and wherein the control circuit is configured to record an indication of the detected instruction to prevent data gating in a subsequent fetch of the detected instruction.

2. The decode unit as recited in claim 1 wherein a program counter address (PC) is associated with the detected instruction, and wherein the control circuit is configured to record at least a portion of the PC as the indication.

3. The decode unit as recited in claim 2 wherein the control circuit is configured to compare the PC associated with a received instruction to the recorded PC and is configured to deactivate the data gating circuit responsive to a match between the PC and the recorded PC.

4. The decode unit as recited in claim 2 further comprising a table configured to store a plurality of PCs including the PC.

5. The decode unit as recited in claim 1 wherein, in response to the detecting another instruction of the first instruction type in one of the other decoders which receives the ungated instruction directly and further in response to the other instruction not being recorded by the control circuit, the control circuit is configured to signal a redirect for the other instruction.

6. A decode unit comprising:
at least one vector decoder configured to decode vector instructions;
at least one additional decoder configured to decode a non-vector instruction type and further configured to detect a vector instruction; and
a control circuit configured to inhibit operation of the vector decoder in response to detecting an absence of vector instructions for a period of time, and wherein the control circuit is configured to enable operation of the vector decoder responsive to an indication from the additional decoder that a vector instruction has been detected.

7. The decode unit as recited in claim 6 comprising a data gating circuit coupled to the control circuit and coupled to provide a data-gated instruction to the vector decoder, and wherein the control circuit is configured to activate the data gating circuit to inhibit operation of the vector decoder and to deactivate the data gating circuit to enable operation of the vector decoder.

8. The decode unit as recited in claim 6 further comprising a counter coupled to the control circuit, wherein the counter is configured to measure the period of time, and wherein the control circuit is configured to initialize the counter responsive to a programmable number of clock cycles.

9. The decode unit as recited in claim 8 wherein the control circuit is configured to reset the counter in response to the indication from the additional decoder that the vector instruction is detected.

10. The decode unit as recited in claim 9 further comprising updating the counter in response to detecting the absence of the vector instruction in a clock cycle.

11. The decode unit as recited in claim 6 wherein the at least one vector decoder comprises a vector integer decoder configured to decode vector integer instructions and a vector floating point decoder configured to decode vector floating point instructions.

12. A method comprising:
deactivating a first decoder of a plurality of decoders in a decode unit, wherein each decoder of the plurality of decoders is configured to decode instructions of a respective instruction type of a plurality of instruction types;
receiving a first instruction to be decoded in the decode unit, wherein the first instruction is of a first instruction type corresponding to the first decoder;
detecting that the first instruction is of the first instruction type and detecting that the first decoder is deactivated;
recording at least part of a program counter address (PC) of the first instruction in a table in the decode unit responsive to detecting the first instruction is of the first instruction type and detecting that the first decoder is deactivated;
comparing PCs of received instructions to PCs in the table; and
activating the first decoder responsive to a match in the comparing.

13. The method as recited in claim 12 further comprising:
redirecting a processor that includes the decoder responsive to detecting that the first instruction is of the first instruction type and detecting that the first decoder is deactivated; and
activating the first decoder responsive to detecting that the first instruction is of the first instruction type and detecting that the first decoder is deactivated.

14. The method as recited in claim 13 further comprising, subsequent to the activating:
detecting an absence of instructions of the first instruction type for a period of time; and
deactivating the first decoder responsive to detecting the absence.

15. The method as recited in claim 14 wherein activating the first decoder responsive to the match in the comparing avoids redirect the processor for the received instructions.

16. The method as recited in claim 12 wherein the first instruction type is a vector instruction type.

17. A processor comprising:
a fetch pipeline configured to fetch instructions for execution; and
one or more decode units coupled to receive fetched instructions from the fetch pipeline, wherein at least a first decode unit of the one or more decode units comprises:
a plurality of decoders, wherein each of the plurality of decoders is configured to decode a different type of instruction;
a data gating circuit coupled to receive an instruction that is provided to the decode unit and configured to gate the instruction, wherein at least one of the plurality of decoders is coupled to receive the gated instruction from the data gating circuit, and wherein other ones of the plurality of decoders are coupled to receive the ungated instruction directly;
a control circuit configured to detect that an instruction of a first instruction type that is decoded by the at least one of the plurality of decoders has not been received for a period of time measured by the control circuit and configured to activate the data gating circuit responsive to detecting that the instruction of the first instruction type has not been received, and wherein the control circuit is configured to continue activating the data gating circuit until the instruction of the first type is detected.

18. The processor as recited in claim 17 wherein the period of time is a programmable number of clock cycles measured in a counter coupled to the control circuit.

19. The processor as recited in claim 18 wherein the control circuit is configured to activate the data gating circuit responsive to the counter expiring.

20. The processor as recited in claim 19 wherein the control circuit is configured to initialize the counter to the number of clock cycles, and wherein the control circuit is configured to reset the counter to the number of clock cycles in response to detecting the instruction of the first instruction type, and wherein the control circuit is configured to decrement the counter each clock cycle that the instruction of the first instruction type is not detected.

21. The processor as recited in claim 17 wherein the one or more decode units are a plurality of decode units, wherein each of the plurality of decode units is the same as the first decode unit.

22. A decode unit comprising:
at least one vector decoder configured to decode vector instructions;
at least one additional decoder configured to decode a non-vector instruction type and further configured to detect a vector instruction;
a data gating circuit coupled to receive an instruction that is provided to the decode unit and configured to gate the instruction, wherein the at least one vector decoder is coupled to receive the gated instruction from the data gating circuit, and wherein the at least one additional decoder is coupled to receive the ungated instruction directly;
a control circuit coupled to the data gating circuit, wherein the control circuit is configured to activate the data gating circuit to inhibit operation of the vector decoder in response to detecting an absence of vector instructions for a period of time measured by the control circuit, and wherein the control circuit is configured to deactivate the data gating circuit to enable operation of the vector decoder responsive to an indication from the additional decoder that a vector instruction has been detected; and
a table coupled to the control circuit, wherein the control circuit is configured to record at least part of a program counter address (PC) of the vector instruction detected by the additional decoder when the vector decoder is deactivated, wherein the control circuit is configured to deactivate the data gating circuit to enable the vector decoder responsive to the PC of a received instruction matching a stored PC in the table.
